(19) United States
(12) Patent Application Publication
(10) Pub. No.: US 2025/0124347 A1
(43) Pub. Date: Apr. 17, 2025

(54) TRAINING MODEL ALLOCATION METHOD, APPARATUS, COMPUTER DEVICE, AND STORAGE MEDIUM

(71) Applicant: ZHEJIANG LAB, Hangzhou (CN)

(72) Inventors: Fei YANG, Hangzhou (CN); Shuang PENG, Hangzhou (CN); Ning SUN, Hangzhou (CN); Fangyu WANG, Hangzhou (CN); Aimin PAN, Hangzhou (CN)

(21) Appl. No.: 18/804,240

(22) Filed: Aug. 14, 2024

Related U.S. Application Data
(63) Continuation of application No. PCT/CN2024/095667, filed on May 28, 2024.

(30) Foreign Application Priority Data
Oct. 16, 2023 (CN) 202311336127.6

(51) Int. Cl. G06N 20/00

(52) U.S. Cl. CPC G06N 20/00

(57) ABSTRACT

A training model allocation method, an apparatus, a computer device, and a storage medium are provided. The method includes: acquiring hierarchy information, calculating parameter information, and a training data set of a to-be-trained model; dividing the to-be-trained model into sub-models according to the hierarchy information, and allocating each of sub-models to machine nodes in a training cluster; dividing each of sub-models into sub-model slices according to the calculating parameter information, and allocating each of sub-model slices to computing processors of the machine nodes in the training cluster; dividing the training data set into training data subsets according to the calculating parameter information, and allocating each of training data subsets to the computing processors in the training cluster; and training the to-be-trained model according to all computing processors, sub-model slices, and training data subsets in the training cluster.

### CROSS-REFERENCE TO RELATED APPLICATIONS

This application is a continuation of international patent application No. PCT/CN2024/095667, filed on May 28, 2024, which itself claims priority to Chinese patent applications No. 202311336127.6, filed on Oct. 16, 2023, titled “TRAINING MODEL ALLOCATION METHOD, APPARATUS, COMPUTER DEVICE, AND STORAGE MEDIUM”. The contents of the above identified applications are hereby incorporated herein in their entireties by reference.

### TECHNICAL FIELD

The present disclosure generally relates to the field of deep learning, and in particular, to a training model allocation method, an apparatus, a computer device, and a storage medium.

### BACKGROUND

In recent years, a trend of more training data and a larger model has not changed in deep learning model training. The larger model may bring more precise and powerful semantic understanding and reasoning capabilities. However, with popularization of scale calculation and increase of data sets, the parameter quantity of the model also increases at an exponential speed. A larger model and a greater data amount mean more computation and storage requirements, and also mean longer training time.

In the related art, model training may be accelerated by parallelism, and deep neural network training may be scaled out by a hardware accelerator in two modes: data parallelism and model parallelism. Data parallelism may implement accelerated model training by segmenting data sets that are input into the model and allocating the data sets to different computing processors respectively. Model parallelism may allocate a memory and computing of the model to multiple computing processors to solve a problem that the model cannot be accommodated on a single computing processor by allocating the model to the computing processors of multiple machine nodes.

However, in the related art, training efficiency of the multiple machine nodes in a heterogeneous communications network is low due to an allocation manner of the model and training data of the model.

### SUMMARY

According to various embodiments of the present disclosure, a training model allocation method, an apparatus, a computer device, and a storage medium are provided.

In a first aspect, a training model allocation method is provided, including: acquiring model information and a training data set of a to-be-trained model, the model information including hierarchy information and calculating parameter information of the to-be-trained model, the hierarchy information including the quantity of hierarchies of the to-be-trained model, and the calculating parameter information including the quantity of calculating tasks of each of the hierarchies of the to-be-trained model and the quantity of computing processors required for each of the calculating tasks, dividing the to-be-trained model into at least two sub-models according to the hierarchy information, and allocating each of the at least two sub-models to machine nodes in a training cluster, dividing each of the at least two sub-models into at least two sub-model slices according to the calculating parameter information, and allocating each of the at least two sub-model slices to computing processors of the machine nodes in the training cluster, dividing the training data set into at least two training data subsets according to the calculating parameter information, and allocating each of the at least two training data subsets to the computing processors in the training cluster, and training the to-be-trained model according to all computing processors in the training cluster and both sub-model slices and training data subsets corresponding to all computing processors.

In an embodiment, dividing the to-be-trained model into the at least two sub-models according to the hierarchy information, and allocating each of the at least two sub-models to the machine nodes in the training cluster further includes: dividing the to-be-trained model into the at least two sub-models according to the hierarchy information, dividing the machine nodes in the training cluster into parallel pipeline groups according to the hierarchy information, and allocating each of the at least two sub-models of the to-be-trained model to machine nodes in corresponding parallel pipeline groups according to the hierarchy information.

In an embodiment, dividing the machine nodes in the training cluster into the parallel pipeline groups according to the hierarchy information further includes: determining the quantity of hierarchies of the to-be-trained model according to the hierarchy information, determining the quantity of hierarchies as the quantity of parallel pipelines, and allocating each of the machine nodes in the training cluster to corresponding one of the parallel pipeline groups according to the quantity of parallel pipelines. When the quantity of parallel pipelines is less than the quantity of the machine nodes in the training cluster, at least one of the parallel pipeline groups includes at least two machine nodes, and the at least two machine nodes in a same parallel pipeline group have different communication protocols.

In an embodiment, dividing each of the at least two sub-models into the at least two sub-model slices according to the calculating parameter information, and allocating each of the at least two sub-model slices to the computing processors of the machine nodes in the training cluster further includes: dividing each of the at least two sub-models into the at least two sub-model slices according to the calculating parameter information, dividing the computing processors of the machine nodes in the training cluster into parallel tensor groups according to the calculating parameter information, and allocating each of the at least two sub-model slices to computing processors in corresponding parallel tensor groups according to the calculating parameter information.

In an embodiment, dividing the computing processors of the machine nodes in the training cluster into the parallel tensor groups according to the calculating parameter information further includes: determining the quantity of the at least two sub-model slices of each of the at least two sub-models according to the calculating parameter information, determining the quantity of the at least two sub-model slices as the quantity of parallel tensors, and allocating each of the computing processors of the machine nodes to corresponding one of the parallel tensor groups according to the quantity of parallel tensors. All the computing processors in a same parallel tensor group belong to a same machine node.

In an embodiment, dividing the training data set into the at least two training data subsets according to the calculating parameter information, and allocating each of the at least two training data subsets to the computing processors in the training cluster further includes: dividing the training data set into the at least two training data subsets according to the calculating parameter information, dividing the computing processors of the machine nodes in the training cluster into parallel data groups according to the calculating parameter information, and allocating each of the at least two training data subsets to computing processors in corresponding parallel data groups according to the calculating parameter information.

In an embodiment, dividing the computing processors of the machine nodes in the training cluster into the parallel data groups according to the calculating parameter information further includes: determining the quantity of parallel data according to the quantity of computing processors required for each of the calculating parameter information, and determining at least two computing processor groups as the parallel data groups according to the quantity of parallel data. The machine nodes at which the computing processors in the data parallel groups are located have a same communication protocol.

In a second aspect, a training model allocation apparatus is further provided, including: a data acquiring module, a first allocation module, a second allocation module, a third allocation module, and a model training module. The data acquiring module is configured for acquiring model information and a training data set of a to-be-trained model. The model information includes hierarchy information and calculating parameter information of the to-be-trained model, the hierarchy information includes the quantity of hierarchies of the to-be-trained model, and the calculating parameter information includes the quantity of calculating tasks of each of the hierarchies of the to-be-trained model and the quantity of computing processors required for each of the calculating tasks. The first allocation module is configured for dividing the to-be-trained model into at least two sub-models according to the hierarchy information, and allocating each of the at least two sub-models to machine nodes in a training cluster. The second allocation module is configured for dividing each of the at least two sub-models into at least two sub-model slices according to the calculating parameter information, and allocating each of the at least two sub-model slices to computing processors of the machine nodes in the training cluster. The third allocation module is configured for dividing the training data set into at least two training data subsets according to the calculating parameter information, and allocating each of the at least two training data subsets to the computing processors in the training cluster. The model training module is configured for training the to-be-trained model according to all computing processors in the training cluster and both sub-model slices and training data subsets corresponding to all computing processors.

In a third aspect, a computer device is further provided, including a memory, a processor, and a computer program stored on the memory and capable of running on the processor. The processor is configured to execute the computer program to implement following steps: acquiring model information and a training data set of a to-be-trained model, the model information including hierarchy information and calculating parameter information of the to-be-trained model, the hierarchy information including the quantity of hierarchies of the to-be-trained model, and the calculating parameter information including the quantity of calculating tasks of each of the hierarchies of the to-be-trained model and the quantity of computing processors required for each of the calculating tasks; dividing the to-be-trained model into at least two sub-models according to the hierarchy information, and allocating each of the at least two sub-models to machine nodes in a training cluster; dividing each of the at least two sub-models into at least two sub-model slices according to the calculating parameter information, and allocating each of the at least two sub-model slices to computing processors of the machine nodes in the training cluster; dividing the training data set into at least two training data subsets according to the calculating parameter information, and allocating each of the at least two training data subsets to the computing processors in the training cluster; and training the to-be-trained model according to all computing processors in the training cluster and both sub-model slices and training data subsets corresponding to all computing processors.

In a fourth aspect, a computer-readable storage medium is further provided. The computer-readable storage medium stores a computer program. The computer program is executed by a processor to implement following steps: acquiring model information and a training data set of a to-be-trained model, the model information including hierarchy information and calculating parameter information of the to-be-trained model, the hierarchy information including the quantity of hierarchies of the to-be-trained model, and the calculating parameter information including the quantity of calculating tasks of each of the hierarchies of the to-be-trained model and the quantity of computing processors required for each of the calculating tasks; dividing the to-be-trained model into at least two sub-models according to the hierarchy information, and allocating each of the at least two sub-models to machine nodes in a training cluster; dividing each of the at least two sub-models into at least two sub-model slices according to the calculating parameter information, and allocating each of the at least two sub-model slices to computing processors of the machine nodes in the training cluster; dividing the training data set into at least two training data subsets according to the calculating parameter information, and allocating each of the at least two training data subsets to the computing processors in the training cluster; and training the to-be-trained model according to all computing processors in the training cluster and both sub-model slices and training data subsets corresponding to all computing processors.

In the above training model allocation method, the apparatus, the computer device, and the storage medium, model information and a training data set of a to-be-trained model are acquired first, the to-be-trained model is divided into at least two sub-models according to the hierarchy information, and the at least two sub-models are allocated to machine nodes in a training cluster. Then the at least two sub-models are divided into at least two sub-model slices according to the calculating parameter information, and the at least two sub-model slices are allocated to computing processors of the machine nodes in the training cluster. The training data set is divided into at least two training data subsets according to the calculating parameter information, and the at least two training data subsets are allocated to the computing processors in the training cluster. The to-be-trained model is trained according to all computing processors in the training cluster and both sub-model slices and training data subsets corresponding to all computing processors. Model allocation is performed by the method in the present disclosure, to solve a problem that training efficiency of multiple machine nodes in a heterogeneous communication network is low.

### BRIEF DESCRIPTION OF THE DRAWINGS

In order to more clearly illustrate the technical solutions in the embodiments of the present disclosure or the related technology, the accompanying drawings to be used in the description of the embodiments or the related technology will be briefly introduced below, and it will be obvious that the accompanying drawings in the following description are only some of the embodiments of the present disclosure, and that, for one skilled in the art, other accompanying drawings can be obtained based on these accompanying drawings without putting in creative labor.

FIG. 1 is a schematic diagram of an application environment of a training model allocation method in an embodiment.

FIG. 2 is a flowchart of a training model allocation method in an embodiment.

FIG. 3 is a schematic diagram of a hierarchy of a to-be-trained model in an embodiment.

FIG. 4 is a flowchart of allocating sub-models to machine nodes in a training cluster in an embodiment.

FIG. 5 is a flowchart of allocating sub-model slices to computing processors of machine nodes in a training cluster in an embodiment.

FIG. 6 is a flowchart of allocating training data subsets to computing processors in a training cluster in an embodiment.

FIG. 7A is a schematic diagram of a division result of parallel pipeline groups and parallel tensor groups in an embodiment.

FIG. 7B is a schematic diagram of a division result of parallel pipeline groups and parallel tensor groups in another embodiment.

FIG. 7C is a schematic diagram of a division result of parallel pipeline groups and parallel tensor groups in another embodiment.

FIG. 8 is a flowchart of a training model allocation method in an embodiment.

FIG. 9 is an internal structural diagram of a computer device in an embodiment.

### DETAILED DESCRIPTION OF THE EMBODIMENT

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure, but not all of the embodiments. Based on the embodiments in the present disclosure, all other embodiments obtained by one skilled in the art without making creative labor fall within the scope of protection of the present disclosure.

To make objectives, technical solutions, and advantages of the present disclosure clearer, the following further describes the present disclosure in detail with reference to the accompanying drawings and embodiments. It should be understood that the specific embodiments described herein are merely used to explain the present disclosure, and are not intended to limit the present disclosure.

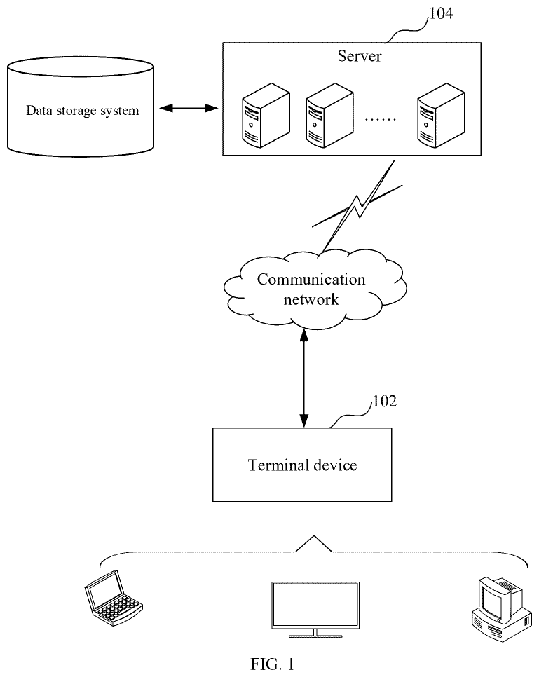

The training model allocation method provided in the present disclosure may be applied to an application environment referring to FIG. 1. A terminal device 102 may be in communication with a server 104 by a network. A data storage system may store model information and a training data set of a to-be-trained model. The data storage system may be integrated on the server 104, or may be placed on a cloud or another network server. The terminal device 102 may be a master node in a training cluster. The terminal device 102 may acquire the model information and the training data set of the to-be-trained model. The model information may include hierarchy information and calculating parameter information of the to-be-trained model, the hierarchy information may include the quantity of hierarchies of the to-be-trained model, and the calculation parameter information may include the quantity of calculating tasks of each of the hierarchies of the to-be-trained model and the quantity of calculation processors required for each of the calculating tasks. The terminal device 102 may divide the to-be-trained model into at least two sub-models according to the hierarchy information, and allocate the at least two sub-models to machine nodes in the training cluster. The terminal device 102 may divide the at least two sub-models into at least two sub-model slices according to the calculating parameter information, and allocate the at least two sub-model slices to computing processors of the machine nodes in the training cluster. The terminal device 102 may divide the training data set into at least two training data subsets according to the calculating parameter information, and allocate the at least two training data subsets to the computing processors in the training cluster. The terminal device 102 may train the to-be-trained model according to all computing processors in the training cluster and both sub-model slices and training data subsets corresponding to all computing processors. The terminal device 102 may be but is not limited to various personal computers, laptops, virtual machines, or the like. The server 104 may be implemented by an independent server or a server cluster composed of multiple servers.

The computing processors in an embodiment of the present disclosure may be but is not limited to a GPU (Graphics Processing Unit), a TPU (Tensor Processing Unit), a NPU (Neural Processing Unit), or the like.

The GPU, the TPU, and the NPU may be types of the computing processors, and configured to accelerate a specific type of a computing task.

The GPU may be originally designed to process graphics and image rendering. However, due to a highly parallel computing capability, the GPU may also be widely used in general computing tasks such as scientific computing, machine learning, deep learning, and the like. The GPU may typically have a large number of computing cores, such as CUDA (Compute Unified Device Architecture) cores or Tensor Cores, that can process multiple data at the same time and perform complex computing operations. Due to the parallel computing capability, the GPU may perform well in training and reasoning a deep learning model.

The TPU may be a special processor developed by Google to optimize deep learning tasks. The TPU may focus on tensor operations, which are data structures widely used in deep learning. The TPU may perform well in training and reasoning the deep learning model and have relatively high energy efficiency. The TPU may be usually used in deep learning services on the cloud and deep learning applications of Google.

The NPU may be a processor dedicated to accelerating neural network computing. Unlike the GPU and the TPU, the NPU may be designed to be more focused on performing neural network calculations and can efficiently handle forward and reverse propagation of the neural network. The NPU may be typically used on mobile devices, smartphones, and Internet of Things devices to achieve high efficiency in performing deep learning reasoning on edge devices.

Overall, the GPU, the TPU, and the NPU may be computing processors designed to accelerate specific types of computing tasks. The GPU, the TPU, and the NPU may exhibit excellent performance and energy efficiency in different application scenarios and requirements.

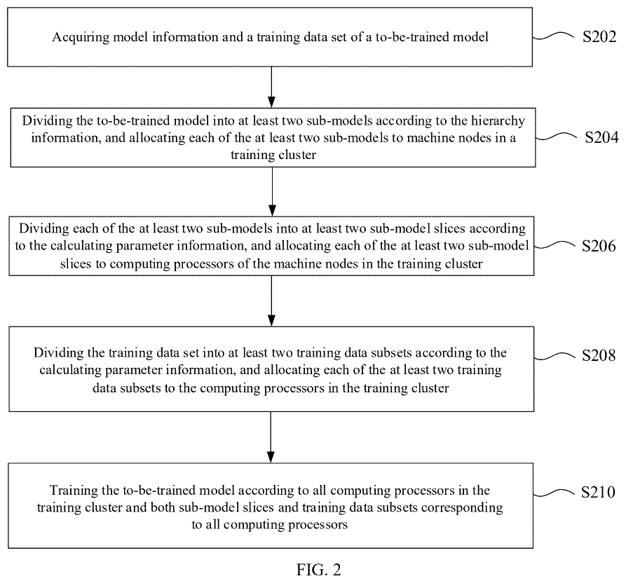

In an embodiment, referring to FIG. 2, a training model allocation method is provided, an example in which the method is applied to the terminal device 102 in FIG. 1 may be used for description, and the method includes following steps 202 to 210.

Step 202 includes acquiring model information and a training data set of a to-be-trained model.

The model information includes hierarchy information and calculating parameter information of the to-be-trained model, the hierarchy information includes the quantity of hierarchies of the to-be-trained model, and the calculating parameter information includes the quantity of calculating tasks of each of the hierarchies of the to-be-trained model and the quantity of computing processors required for each of the calculating tasks.

Step 204 includes dividing the to-be-trained model into at least two sub-models according to the hierarchy information, and allocating each of the at least two sub-models to machine nodes in a training cluster.

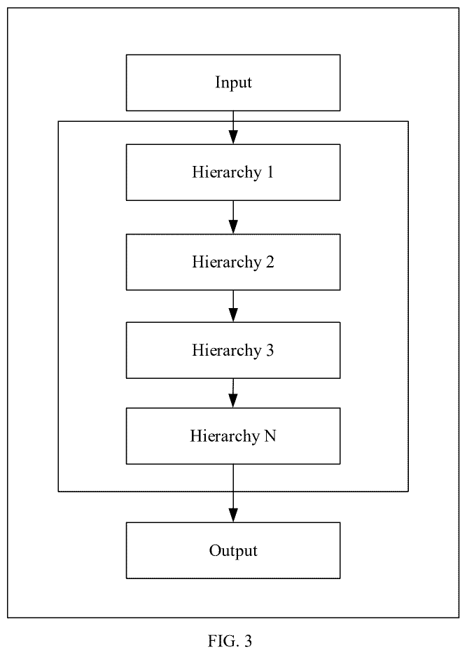

The sub-models may be to-be-trained models in the hierarchies determined according to the hierarchy information. Exemplarily, referring to FIG. 3, the to-be-trained model may include N hierarchies from hierarchy 1 to hierarchy N between an input and an output, and the to-be-trained models in the N hierarchies may be determined as N sub-models, the machine nodes may be independent computer systems in the training cluster, and each of the machine node may include at least two computing processors.

Step 206 includes dividing each of the at least two sub-models into at least two sub-model slices according to the calculating parameter information, and allocating each of the at least two sub-model slices to computing processors of the machine nodes in the training cluster.

The sub-model slices may represent the calculating tasks of the to-be-trained models in the hierarchies. Exemplarily, referring to FIG. 3, it may be assumed that in the to-be-trained models of hierarchy 1 to hierarchy N, the to-be-trained model in each hierarchy may include two calculating tasks, and two sub-model slices may be obtained by dividing a sub-model corresponding to a hierarchy according to calculating parameter information.

Step 208 includes dividing the training data set into at least two training data subsets according to the calculating parameter information, and allocating each of the at least two training data subsets to the computing processors in the training cluster.

Specifically, dividing the training data set into the at least two training data subsets according to the calculating parameter information, and allocating each of the at least two training data subsets to the computing processors in the training cluster may further include: determining, according to the quantity of computing processors required by computing tasks, the quantity of training data subsets required by the computing tasks, and evenly allocating the training data subsets of the computing tasks in the training data set to the computing processors that processes the computing tasks.

Step 210 includes training the to-be-trained model according to all computing processors in the training cluster and both sub-model slices and training data subsets corresponding to all computing processors.

Specifically, communication protocols used between machine nodes at which the computing processors are located may be determined according to all computing processors in the training cluster and both sub-model slices and training data subsets corresponding to all computing processors, the to-be-trained model may be trained based on the communication protocols used between machine nodes at which the computing processors are located, and a model training result may be summarized.

The communication protocols used between machine nodes in the training cluster may include RoCE (RDMA over Converged Ethernet), IB (Infiniband), and TCP/IP (Ethernet communication protocol). The RoCE and the IB belong to a RDMA (Remote Direct Memory Access) technology. Because the RDMA technology can directly access memory data by a network interface, no interference from an operating system kernel is required. Thus, a network communication with high throughput and low latency may be constructed by the RoCE and the IB, which is particularly suitable for use in large-scale parallel computer clusters. Exemplarily, the communication protocols used between machine nodes at which the computing processors are located may be determined in the following manner: when machine nodes at which two computing processors that need to communicate are located are in a same high-speed network cluster (IB or RoCE), a high-speed network may be used for communication. When the machine nodes at which the two computing processors that need to communicate are located are in different high-speed network clusters, if both communication protocols of the machine nodes are compatible (for example, both communication protocols are IB or RoCE), the high-speed network may be used for communication, and if both communication protocols of the machine nodes are not compatible, the Ethernet communication protocol may be used for communication.

In the training model allocation method of the present embodiment, model information and a training data set of a to-be-trained model are acquired first, the to-be-trained model is divided into at least two sub-models according to the hierarchy information, and the at least two sub-models are allocated to machine nodes in a training cluster. Then the at least two sub-models are divided into at least two sub-model slices according to the calculating parameter information, and the at least two sub-model slices are allocated to computing processors of the machine nodes in the training cluster. The training data set is divided into at least two training data subsets according to the calculating parameter information, and the at least two training data subsets are allocated to the computing processors in the training cluster. The to-be-trained model is trained according to all computing processors in the training cluster and both sub-model slices and training data subsets corresponding to all computing processors. The to-be-trained model is divided into the sub-models and the sub-model slices, the training data set is divided into the training data subsets to be allocated to the computing processors, and model parallelism may be combined with data parallelism, thereby solving a problem that training efficiency of multiple machine nodes in a heterogeneous communication network is low.

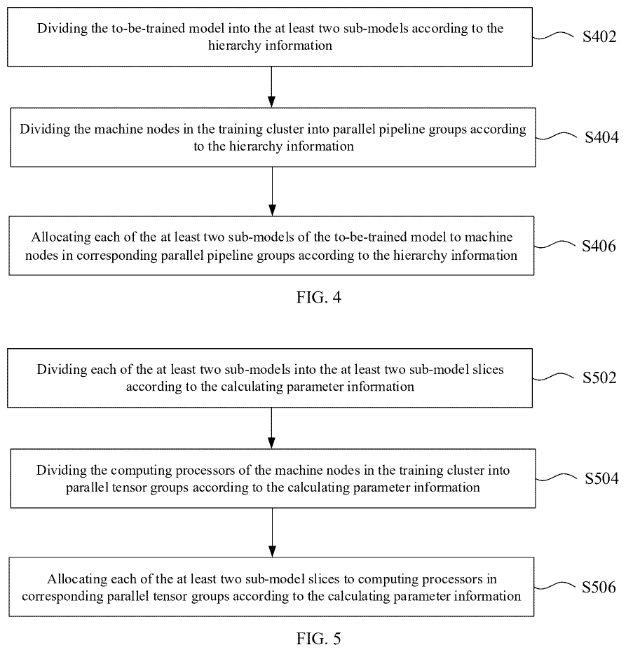

In an embodiment, referring to FIG. 4, dividing the to-be-trained model into the at least two sub-models according to the hierarchy information, and allocating each of the at least two sub-models to the machine nodes in the training cluster may further include step 402 to step 406.

Step 402 may include dividing the to-be-trained model into the at least two sub-models according to the hierarchy information.

Step 404 may include dividing the machine nodes in the training cluster into parallel pipeline groups according to the hierarchy information.

Specifically, the quantity of hierarchies of the to-be-trained model may be determined according to the hierarchy information. The quantity of hierarchies may be determined as the quantity of parallel pipelines. Each of the machine nodes in the training cluster may be allocated to corresponding one of the parallel pipeline groups according to the quantity of parallel pipelines. When the quantity of parallel pipelines is less than the quantity of the machine nodes in the training cluster, at least one of the parallel pipeline groups may include at least two machine nodes.

The parallel pipeline groups may represent groups of machine nodes to process different sub-models of the to-be-trained model, and at least two machine nodes in a same pipeline parallel group may have different communication protocols. The quantity of parallel pipelines may represent the quantity of parallel machine nodes to process different sub-models, and the quantity of parallel machine nodes may be determined according to the quantity of hierarchies of the to-be-trained model.

Exemplarily, the to-be-trained model may have three hierarchies in total, and the quantity of parallel pipeline may be 3. In this case, when the quantity of the machine nodes in the training cluster is 4, the parallel pipeline groups may be divided according to a following manner: a first machine node may be allocated to a first parallel pipeline group, a second machine node may be allocated to a second parallel pipeline group, a third machine node and a fourth machine node may be allocated to a third parallel pipeline group, and the third machine node and the fourth machine node may have different communication protocols.

In the present embodiment, division of the parallel pipeline groups may be performed. Because the machine nodes that process the sub-models corresponding to different hierarchies of the to-be-trained model have different communication protocols, more machine nodes that have a same communication protocol can be divided to a same sub-model, thereby improving communication efficiency in model training and accelerating model training.

Step 406 may include allocating each of the at least two sub-models of the to-be-trained model to machine nodes in corresponding parallel pipeline groups according to the hierarchy information.

Specifically, sub-models corresponding to hierarchies of the to-be-trained model may be determined according to the hierarchy information, each of the sub-models corresponding to hierarchies of the to-be-trained model may be allocated to the machine nodes in parallel pipeline groups, and each of the machine nodes may obtain one sub-model of the to-be-trained model at most.

In the method of the present disclosure, the to-be-trained model may be divided into the at least two sub-models according to the hierarchy information first, then the machine nodes in the training cluster may be divided into parallel pipeline groups according to the hierarchy information, finally the at least two sub-models of the to-be-trained model may be allocated to machine nodes in corresponding parallel pipeline groups according to the hierarchy information. In the method of the present disclosure, hierarchies of the to-be-trained model may be divided into the sub-models, and the sub-models may be allocated to the machine nodes. Because computing processors of the machine nodes in the training cluster are fully used, a problem that a to-be-trained model cannot be accommodated on a computing processor of a machine node may be solved, and training efficiency of a large model may be improved.

In an embodiment, referring to FIG. 5, dividing each of the at least two sub-models into the at least two sub-model slices according to the calculating parameter information, and allocating each of the at least two sub-model slices to the computing processors of the machine nodes in the training cluster may further include step 502 to step 506.

Step 502 may include dividing each of the at least two sub-models into the at least two sub-model slices according to the calculating parameter information.

Specifically, the quantity of sub-model slices obtained by dividing each of the at least two sub-models may be determined according to the quantity of calculating parameters in the calculating parameter information, and the at least two sub-models may be divided into at least two sub-model slices according to the quantity of sub-model slices. The at least two sub-models may include multiple groups of calculating parameters that need to be calculated in hierarchies of the to-be-trained model, and the quantity of calculating parameters may represent the number of groups of calculating parameters which are included in hierarchies of the to-be-trained model.

Step 504 may include dividing the computing processors of the machine nodes in the training cluster into parallel tensor groups according to the calculating parameter information.

Specifically, the quantity of the at least two sub-model slices of each of the at least two sub-models may be determined according to the quantity of calculating parameters in the calculating parameter information, the quantity of the at least two sub-model slices may be determined as the quantity of parallel tensors, and each of the computing processors of the machine nodes may be allocated to corresponding one of the parallel tensor groups according to the quantity of parallel tensors.

The parallel tensor groups may represent a group of machine nodes to process different calculating parameters in the sub-models, and all calculating processors in a same parallel tensor group belong to a same machine node. The quantity of parallel tensors may represent the quantity of computing processors included in a same parallel tensor group.

The division of the parallel tensor groups may be performed in the present embodiment. Because the computing processors that process a same sub-model have a same communication protocol, communication efficiency in the model training may be improved, and the model training may be accelerated.

Step 506 may include allocating each of the at least two sub-model slices to computing processors in corresponding parallel tensor groups according to the calculating parameter information.

Specifically, the sub-model slices corresponding to the sub-models may be determined according to calculating parameter information, and the sub-model slices corresponding to the sub-models may be allocated to the computing processors in the parallel tensor groups. Each computing processor may obtain one sub-model slice at most.

In the method of the present embodiment, the at least two sub-models may be divided into the at least two sub-model slices according to the calculating parameter information, the computing processors of the machine nodes in the training cluster may be divided into parallel tensor groups according to the calculating parameter information, and the at least two sub-model slices may be allocated to the computing processors in corresponding parallel tensor groups according to the calculating parameter information. In the method of the present embodiment, the at least two sub-model slices of the to-be-trained model may be allocated to the machine nodes, and the at least two sub-model slices may be further allocated to different computing processors based on dividing the to-be-trained model into the sub-models. Therefore, a problem that the to-be-trained model cannot be accommodated on a computing processor of a machine node may be solved, and training efficiency of the large model may be improved.

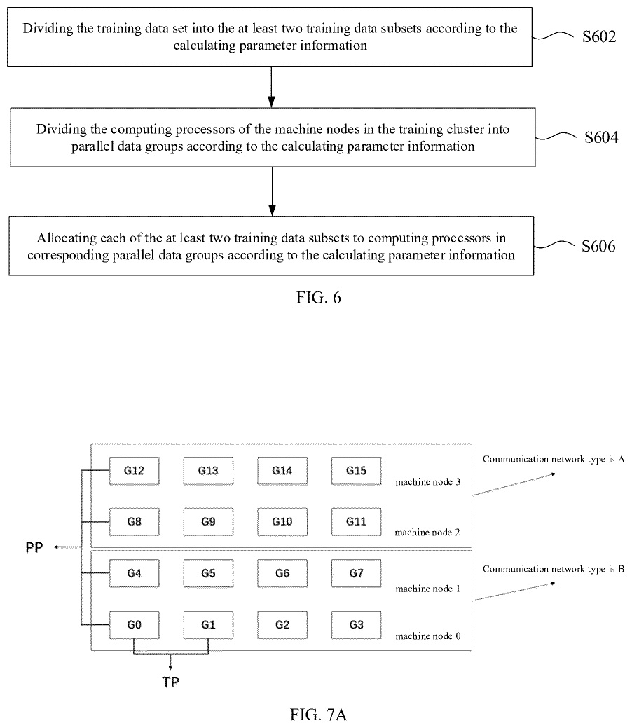

In an embodiment, referring to FIG. 6, dividing the training data set into the at least two training data subsets according to the calculating parameter information, and allocating each of the at least two training data subsets to the computing processors in the training cluster may further include step 602 to step 606.

Step 602 may include dividing the training data set into the at least two training data subsets according to the calculating parameter information.

Specifically, training data required for each group of calculating parameters may be determined according to the calculating parameter information, and the training data required for each group of calculating parameters may be divided into the training data subsets.

Step 604 may include dividing the computing processors of the machine nodes in the training cluster into parallel data groups according to the calculating parameter information.

Specifically, the quantity of training data subsets of each group of calculating parameters may be determined according to the calculating parameter information, and the computing processors of the machine nodes in the training cluster may be divided into parallel data groups according to the quantity of training data subsets.

Specifically, the quantity of parallel data may be determined according to the quantity of computing processors required for each of the calculating parameter information. At least two computing processor groups may be determined as parallel data groups according to the quantity of parallel data. The machine nodes at which the computing processors in the data parallel groups are located may have a same communication protocol.

The division of the parallel data groups may be performed in the present embodiment. Because the computing processors that process a same batch of training data have a same communication protocol, communication efficiency in the model training may be improved, and the model training may be accelerated.

Step 606 may include allocating each of the at least two training data subsets to computing processors in corresponding parallel data groups according to the calculating parameter information.

Specifically, the quantity of training data subsets of each group of calculating parameters may be determined according to the calculating parameter information, and the training data subsets may be allocated to the computing processors in corresponding parallel data groups. Each computing processor may obtain one training data subset at most.

In the method of the present embodiment, the training data set may be divided into the at least two training data subsets according to the calculating parameter information, the computing processors of the machine nodes in the training cluster may be divided into the parallel data groups according to the calculating parameter information, and the at least two training data subsets may be allocated to the computing processors in corresponding parallel data groups according to the calculating parameter information. The training data set may be divided into training data subsets by the method in the present embodiment, and allocated to the computing processors. Based on parallel pipeline processing and parallel tensor processing performed on the to-be-trained model, the training data sets configured for model training may be further allocated to different computing processors. Therefore, computing resource of the computing processors of the machine nodes in the training cluster may be fully utilized, and training efficiency of the large model may be improved.

In an embodiment, the method of the present disclosure may further be applied in an application environment of a heterogeneous communication network. The heterogeneous communication network may include at least two training clusters, and machine nodes in the at least two training clusters may use at least two different communication protocols, such as at least two communication protocols in RoCE, IB, and TCP/IP. In this case, the computing processors may be numbered according to the quantity of training clusters, the quantity of machine nodes in the training clusters, and the quantity of computing processors in the machine nodes, so as to determine locations of the computing processors in the heterogeneous communication network. The computing processors of the machine nodes may be numbered according to division of the parallel pipeline groups, the parallel tensor groups, and the parallel data groups, so as to determine locations of the computing processors in the training clusters.

Exemplarily, in the heterogeneous communication network, it is assumed that the quantity of the training clusters in different communication networks is m (m≥2), the quantity of the machine nodes in a training cluster numbered a (0≤a≤m) is nₐ (nₐ>0), and the quantity of the computing processors on any of the machine nodes is c (c>0). The training clusters, the machine nodes, and the computing processors may be numbered in sequence. A total quantity of the computing processors in all the training clusters is c×Σᵢ₌₀^{m-1}nᵢ. A global number of a computing processor numbered k on a machine node b in a training cluster a in the heterogeneous communication network may be defined as follows: rank_{c×((Σ}_{ᵢ₌₀}_{^{a}}ₙ_{ᵢ}_{)+b)+k}.

When model training is performed in the heterogeneous communication network by the method of the present disclosure, for one of the training clusters, it is assumed that the quantity of parallel pipelines is p (p≥m), the quantity of parallel tensors is t (t≤c), and the quantity of parallel data is d, a total quantity of computing processors in all the training clusters is p*t*d. When the machine nodes in the training clusters are divided into the parallel pipeline groups, the to-be-trained model may need to be divided into the at least two sub-models according to the hierarchy information of the to-be-trained model. When the quantity of parallel pipelines is p (p≥m), the quantity of the parallel pipeline groups is t*d, and the obtained parallel pipeline groups may represent a matrix PP of t*d*p. As shown in the following formula (1), an element [PP]ᵢⱼ in the matrix may represent a computing processor j in a parallel pipeline group i.

$${[ P P ]}_{ij} = {rank}_{i + t * d * j} \begin{matrix}i ∈ \{ 0 , 1 , 2 , … , t * d - 1 \} \\ j ∈ \{ 0 , 1 , 2 , … , p - 1 \}\end{matrix} \qquad ( 1 )$$

When the machine nodes in the training clusters are divided into the parallel tensor groups, and the quantity of the parallel tensors is t (t≤c), the quantity of the parallel tensor groups is p*d, the obtained parallel tensor groups may represent a matrix TP of p*d×t. As shown in the following formula (1), an element [TP]ᵢⱼ in the matrix may represent a computing processor j in a parallel tensor group i.

$${[ T P ]}_{i j} = {rank}_{t * i + j} \begin{matrix}i ∈ \{ 0 , 1 , 2 , … , t * d - 1 \} \\ j ∈ \{ 0 , 1 , 2 , … , t - 1 \}\end{matrix} \qquad ( 2 )$$

When the quantity of the parallel data is d (d≤c), the quantity of the parallel data groups is p*t, the obtained parallel data groups may represent a matrix DP of p*t×d. As shown in the following formula (3), an element [DP]_{i,j} in the matrix may represent a computing processor j in a parallel data group i.

$${[ D P ]}_{ij} = {rank}_{m o d ( i , t ) + floo r ( \frac{i}{t} ) * t * d + t * j} \begin{matrix}i ∈ \{ 0 , 1 , 2 , … , p * t - 1 \} \\ j ∈ \{ 0 , 1 , 2 , … , d - 1 \}\end{matrix} \qquad ( 3 )$$

In the formula (3), mod(i, t) may represent a remainder of a division operation performed by i and t, and floor (x) may represent that x is rounded down.

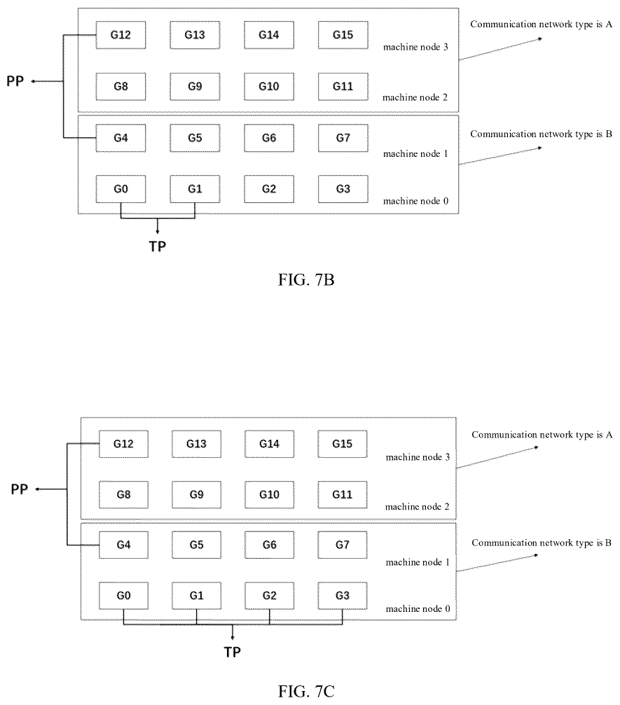

Referring to FIG. 7A to FIG. 7C, FIG. 7A to FIG. 7C are schematic diagrams of a division result of parallel pipeline groups and parallel tensor groups in a training cluster in the heterogeneous communication network in the present embodiment. Four machine nodes such as a machine node 0 to a machine node 3 may be included, and four computing processors may be disposed on each of the machine nodes. In a training cluster, there are 16 computing processors: G0 to G15. Positions of the computing processors in the training cluster may be uniquely determined by the foregoing formula (1) to formula (2).

In the present embodiment, the computing processors may be numbered according to the quantity of the training clusters, the quantity of the machine nodes, and the quantity of computing processors. The computing processors may be numbered according to division of the parallel pipeline groups, the parallel tensor groups, and the parallel data groups. Therefore, locations of the computing processors in an entire communication network and a specific training cluster may be accurately determined.

It should be understood that, although steps in the flowchart related to the foregoing embodiments are sequentially displayed according to an instruction of an arrow, these steps are not necessarily sequentially performed according to the instruction of the arrow. Unless expressly stated in the specification, these steps are not performed in a strict order, and these steps may be performed in another order. In addition, at least two parts of steps in the flowchart involved in the foregoing embodiments may include multiple steps or multiple phases. These steps or phases are not necessarily performed at a same moment, but may be performed at different moments. An execution sequence of these steps or phases is not necessarily performed sequentially, but may be performed alternately or alternately with at least two parts of steps or phases in another step or another step.

Based on a same inventive concept, an embodiment of this application further provides a training model allocation apparatus for implementing the foregoing involved training model allocation method. An implementation solution provided by the apparatus is similar to the implementation solution described in the foregoing method. Therefore, for a specific limitation in one or more training model allocation apparatus embodiments provided below, refer to the foregoing limitation on a training model allocation method. Details are not described herein again.

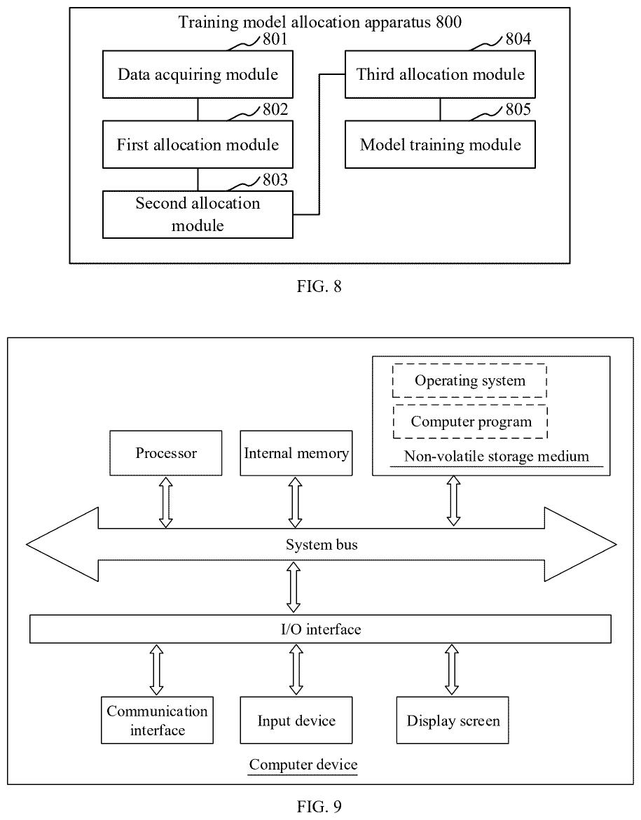

In an embodiment, referring to FIG. 8, a training model allocation apparatus 800 is provided, including a data acquiring module 801, a first allocation module 802, a second allocation module 803, a third allocation module 804, and a model training module 805.

The data acquiring module 801 is configured for acquiring model information and a training data set of a to-be-trained model. The model information includes hierarchy information and calculating parameter information of the to-be-trained model, the hierarchy information includes the quantity of hierarchies of the to-be-trained model, and the calculating parameter information includes the quantity of calculating tasks of each of the hierarchies of the to-be-trained model and the quantity of computing processors required for each of the calculating tasks.

The first allocation module 802 is configured for dividing the to-be-trained model into at least two sub-models according to the hierarchy information, and allocating each of the at least two sub-models to machine nodes in a training cluster.

The second allocation module 803 is configured for dividing each of the at least two sub-models into at least two sub-model slices according to the calculating parameter information, and allocating each of the at least two sub-model slices to computing processors of the machine nodes in the training cluster.

The third allocation module 804 is configured for dividing the training data set into at least two training data subsets according to the calculating parameter information, and allocating each of the at least two training data subsets to the computing processors in the training cluster.

The model training module 805 is configured for training the to-be-trained model according to all computing processors in the training cluster and both sub-model slices and training data subsets corresponding to all computing processors.

In an embodiment, the first allocation module 802 is further configured for dividing the to-be-trained model into the at least two sub-models according to the hierarchy information, dividing the machine nodes in the training cluster into parallel pipeline groups according to the hierarchy information, and allocating each of the at least two sub-models of the to-be-trained model to machine nodes in corresponding parallel pipeline groups according to the hierarchy information.

In an embodiment, the first allocation module 802 is further configured for determining the quantity of hierarchies of the to-be-trained model according to the hierarchy information, determining the quantity of hierarchies as the quantity of parallel pipelines, and allocating each of the machine nodes in the training cluster to corresponding one of the parallel pipeline groups according to the quantity of parallel pipelines. When the quantity of parallel pipelines is less than the quantity of the machine nodes in the training cluster, at least one of the parallel pipeline groups includes at least two machine nodes, and the at least two machine nodes in a same parallel pipeline group have different communication protocols.

In an embodiment, the second allocation module 803 is further configured for dividing each of the at least two sub-models into the at least two sub-model slices according to the calculating parameter information, dividing the computing processors of the machine nodes in the training cluster into parallel tensor groups according to the calculating parameter information, and allocating each of the at least two sub-model slices to computing processors in corresponding parallel tensor groups according to the calculating parameter information.

In an embodiment, the second allocation module 803 is further configured for determining the quantity of the at least two sub-model slices of each of the at least two sub-models according to the calculating parameter information, determining the quantity of the at least two sub-model slices as the quantity of parallel tensors, and allocating each of the computing processors of the machine nodes to corresponding one of the parallel tensor groups according to the quantity of parallel tensors. All the computing processors in a same parallel tensor group belong to a same machine node.

In an embodiment, the third allocation module 804 is further configured for dividing the training data set into the at least two training data subsets according to the calculating parameter information, dividing the computing processors of the machine nodes in the training cluster into parallel data groups according to the calculating parameter information, and allocating each of the at least two training data subsets to computing processors in corresponding parallel data groups according to the calculating parameter information.

In an embodiment, the third allocation module 804 is further configured for determining the quantity of parallel data according to the quantity of computing processors required for each of the calculating parameter information, and determining at least two computing processor groups as the parallel data groups according to the quantity of parallel data. The machine nodes at which the computing processors in the data parallel groups are located have a same communication protocol.

All modules in the foregoing training model allocation apparatus 800 may be implemented in whole or in part by software, hardware, and a combination thereof. The foregoing modules may be embedded in or independent of a processor in a computer device in a hardware form, or may be stored in a memory in the computer device in a software form, so that the processor may invoke to execute an operation corresponding to the foregoing modules.

In an embodiment, a computer device is provided. The computer device may be a terminal, and an internal structure diagram of the computer device may be shown in FIG. 9. The computer device includes a processor, a memory, a communication interface, a display screen, and an input apparatus that are connected by a system bus. The processor of the computer device is configured to provide a computing and control capability. The memory of the computer device includes a non-volatile storage medium and an internal memory. The non-volatile storage medium stores an operating system and a computer program. The internal memory provides an environment for running the operating system and the computer program in a non-volatile storage medium. The communication interface of the computer device is configured to be in communication with an external terminal in a wired or wireless manner. The wireless manner may be implemented by a WIFI, a mobile cellular network, a NFC (near field communication), or another technology. The computer program is executed by a processor to implement the training model allocation method. The display screen of the computer device may be a liquid crystal display screen or an electronic ink display screen. The input apparatus of the computer device may be a touch layer covered on the display screen, may be a key, a trackball, or a touchpad disposed on a housing of the computer device, or may be an external keyboard, a touchpad, or a mouse.

One skilled in the art may understand that the structure shown in FIG. 9 is merely a block diagram of some structures related to the solutions of the present disclosure, and does not constitute a limitation on a computer device to which the solutions of the present disclosure are applied. A specific computer device may include more or fewer components than those shown in the figure, or combine some components, or have different component arrangements.

In an embodiment, a computer device is further provided, including a memory and a processor. The memory stores a computer program, and the processor implements steps in the foregoing method embodiments when executing the computer program.

In an embodiment, a computer readable storage medium is provided, and a computer program is stored thereon. When being executed by a processor, the computer program implements the steps in the foregoing method embodiments.

It should be noted that user information (including but not limited to user equipment information, user personal information, and the like) and data (including but not limited to data used for analysis, stored data, and displayed data) related to the present disclosure are information and data that are authorized by a user or that are fully authorized by each party.

One skilled in the art may understand that all or a part of the processes in the methods in the foregoing embodiments may be implemented by a computer program instructing related hardware. The computer program may be stored in a non-volatile computer readable storage medium. When the computer program is executed, the processes in the foregoing methods embodiments may be included. Any reference to a memory, a database, or another medium used in the embodiments provided in the present disclosure may include at least one of a non-volatile memory or a volatile memory. The non-volatile memory may include a Read-Only Memory (ROM), a magnetic tape, a floppy disk, a flash memory, an optical memory, a high-density embedded non-volatile memory, a Resistive Random Access Memory (ReRAM), a Magneto resistive Random Access Memory (MRAM), a Ferroelectric Random Access Memory (FRAM), a Phase Change Memory (PCM), a graphene memory, and the like. The volatile memory may include a Random Access Memory (RAM), an external cache, or the like. As an illustration and not a limitation, the RAM may be in multiple forms, such as a Static Random Access Memory (SRAM) or a Dynamic Random Access Memory (DRAM). The databases involved in the embodiments provided in the present disclosure may include at least one of a relational database or a non-relational database. The non-relational database may include a distributed database based on block chain or the like, which is not limited thereto. The processor in the embodiments provided in the present disclosure may be a general processor, a central processing unit, a graphics processor, a digital signal processor, a programmable logic device, a data processing logic device based on quantum computing, or the like, which is not limited thereto.

The various technical features of the above-described embodiments may be combined arbitrarily, and all possible combinations of the various technical features of the above-described embodiments have not been described for the sake of conciseness of description. However, as long as there is no contradiction in the combinations of these technical features, they should be considered to be within the scope of the present specification.

The above-described embodiments express only several embodiments of the present disclosure, which are described in a more specific and detailed manner, but are not to be construed as a limitation on the scope of the present disclosure. For one skilled in the art, several deformations and improvements can be made without departing from the conception of the present disclosure, all of which fall within the scope of protection of the present disclosure. Therefore, the scope of protection of the present disclosure shall be subject to the attached claims.

1. A training model allocation method, comprising:
acquiring model information and a training data set of a to-be-trained model, wherein the model information comprises hierarchy information and calculating parameter information of the to-be-trained model, the hierarchy information comprises the quantity of hierarchies of the to-be-trained model, and the calculating parameter information comprises the quantity of calculating tasks of each of the hierarchies of the to-be-trained model and the quantity of computing processors required for each of the calculating tasks;
dividing the to-be-trained model into at least two sub-models according to the hierarchy information;
determining the quantity of hierarchies of the to-be-trained model according to the hierarchy information;
determining the quantity of hierarchies as the quantity of parallel pipelines;
allocating each of machine nodes in a training cluster to corresponding one of parallel pipeline groups according to the quantity of parallel pipelines, wherein when the quantity of parallel pipelines is less than the quantity of the machine nodes in the training cluster, at least one of the parallel pipeline groups comprises at least two machine nodes, and the at least two machine nodes in a same parallel pipeline group have different communication protocols;
allocating each of the at least two sub-models of the to-be-trained model to machine nodes in corresponding parallel pipeline groups according to the hierarchy information;
dividing each of the at least two sub-models into at least two sub-model slices according to the calculating parameter information, and allocating each of the at least two sub-model slices to computing processors of the machine nodes in the training cluster;
dividing the training data set into at least two training data subsets according to the calculating parameter information, and allocating each of the at least two training data subsets to the computing processors in the training cluster; and
training the to-be-trained model according to all computing processors in the training cluster and both sub-model slices and training data subsets corresponding to all computing processors.

2. (canceled)

3. (canceled)

4. The method of claim 1, wherein dividing each of the at least two sub-models into the at least two sub-model slices according to the calculating parameter information, and allocating each of the at least two sub-model slices to the computing processors of the machine nodes in the training cluster further comprises:
dividing each of the at least two sub-models into the at least two sub-model slices according to the calculating parameter information;
dividing the computing processors of the machine nodes in the training cluster into parallel tensor groups according to the calculating parameter information; and
allocating each of the at least two sub-model slices to computing processors in corresponding parallel tensor groups according to the calculating parameter information.

5. The method of claim 4, wherein dividing the computing processors of the machine nodes in the training cluster into the parallel tensor groups according to the calculating parameter information further comprises:
determining the quantity of the at least two sub-model slices of each of the at least two sub-models according to the calculating parameter information;
determining the quantity of the at least two sub-model slices as the quantity of parallel tensors; and
allocating each of the computing processors of the machine nodes to corresponding one of the parallel tensor groups according to the quantity of parallel tensors, wherein all the computing processors in a same parallel tensor group belong to a same machine node.

6. The method of claim 1, wherein dividing the training data set into the at least two training data subsets according to the calculating parameter information, and allocating each of the at least two training data subsets to the computing processors in the training cluster further comprises:
dividing the training data set into the at least two training data subsets according to the calculating parameter information;
dividing the computing processors of the machine nodes in the training cluster into parallel data groups according to the calculating parameter information; and
allocating each of the at least two training data subsets to computing processors in corresponding parallel data groups according to the calculating parameter information.

7. The method of claim 6, wherein dividing the computing processors of the machine nodes in the training cluster into the parallel data groups according to the calculating parameter information further comprises:
determining the quantity of parallel data according to the quantity of computing processors required for each of the calculating parameter information; and
determining at least two computing processor groups as the parallel data groups according to the quantity of parallel data, wherein the machine nodes at which the computing processors in the parallel data groups are located have a same communication protocol.

8. A training model allocation apparatus, comprising a data acquiring module, a first allocation module, a second allocation module, a third allocation module, and a model training module,
wherein the data acquiring module is configured for acquiring model information and a training data set of a to-be-trained model, the model information comprises hierarchy information and calculating parameter information of the to-be-trained model, the hierarchy information comprises the quantity of hierarchies of the to-be-trained model, and the calculating parameter information comprises the quantity of calculating tasks of each of the hierarchies of the to-be-trained model and the quantity of computing processors required for each of the calculating tasks;
the first allocation module is configured for dividing the to-be-trained model into at least two sub-models according to the hierarchy information, determining the quantity of hierarchies of the to-be-trained model according to the hierarchy information, determining the quantity of hierarchies as the quantity of parallel pipelines, allocating each of machine nodes in a training cluster to corresponding one of parallel pipeline groups according to the quantity of parallel pipelines, and allocating each of the at least two sub-models of the to-be-trained model to machine nodes in corresponding parallel pipeline groups according to the hierarchy information, wherein when the quantity of parallel pipelines is less than the quantity of the machine nodes in the training cluster, at least one of the parallel pipeline groups comprises at least two machine nodes, and the at least two machine nodes in a same parallel pipeline group have different communication protocols;
the second allocation module is configured for dividing each of the at least two sub-models into at least two sub-model slices according to the calculating parameter information, and allocating each of the at least two sub-model slices to computing processors of the machine nodes in the training cluster;
the third allocation module is configured for dividing the training data set into at least two training data subsets according to the calculating parameter information, and allocating each of the at least two training data subsets to the computing processors in the training cluster; and
the model training module is configured for training the to-be-trained model according to all computing processors in the training cluster and both sub-model slices and training data subsets corresponding to all computing processors.

9. A computer device, comprising a memory and a processor, wherein a computer program is stored in the memory, and the processor is configured to execute the computer program to implement steps of the method of claim 1.

10. A computer-readable storage medium, storing a computer program, wherein the computer program is executed by a processor to implement steps of the method of claim 1.
